(19) United States
(12) Patent Application Publication
(10) Pub. No.: US 2009/0033176 A1
(43) Pub. Date: Feb. 5, 2009

(54) SYSTEM AND METHOD FOR LONG TERM POWER IN WELL APPLICATIONS

(75) Inventors: Songming Huang, Cambridgeshire (GB); Thomas D. MacDougall, Sugar Land, TX (US); Benjamin P. Jeffryes, Cambs (GB)

Correspondence Address: Patent Counsel;Schlumberger Reservoir Completions, Schlumberger Technology Corporation, 14910 Airline Road, Rosharon, TX, 77583, US

(73) Assignee: SCHLUMBERGER TECHNOLOGY CORPORATION, Sugar Land, TX (US)

(21) Appl. No.: 11/830,504

(22) Filed: Jul. 30, 2007

(51) Int. Cl. E21B 28/00; H02J 15/00; H02N 2/18; E21B 41/00; H02J 11/00

(52) U.S. Cl. 310/334; 166/244.1; 166/177.2; 166/113; 322/2 R; 181/141; 367/137; 367/191

(57) ABSTRACT

A technique is provided by which energy is physically/mechanically transmitted down through a wellbore. The transmitted energy is directed downhole along a fluid channel and impinges on an energy converter positioned in the wellbore or at another subterranean location. The energy converter converts the physical energy into electrical energy that can be supplied to a downhole device.

### BACKGROUND

In many well related applications, various components are utilized downhole that require electrical energy for some aspect of operation. These components are powered either by electrical cables routed down through the wellbore or by remote power sources, such as batteries positioned downhole proximate the component to be powered. The use of power cables often is not feasible or cost-effective in many types of well related applications. However, providing a continual source of electrical energy with a battery located downhole also has limitations. For example, the battery has a limited life, particularly when in continuous electrical connection with the downhole component.

In completions and testing operations, communication of commands from a surface location to a downhole system can be necessary to control the actuation or other function of the downhole system. To process the commands, the downhole system has a receiver that remains operating to accept the commands. Operating the receiver requires power which can be supplied by a battery. However, the time period over which commands can be sent is limited by the amount of energy contained in the battery and by the need to maintain the receiver in an operational state.

### SUMMARY

In general, the present invention provides a system and method by which energy is physically/mechanically transmitted down through a wellbore. The energy may be in the form of waves created by a wave generator that directs the waves downhole along a fluid channel until they impinge on an energy converter positioned at a subterranean location, e.g. in the wellbore. The energy converter converts the physical or mechanical energy into electrical energy that is supplied to a downhole device.

### BRIEF DESCRIPTION OF THE DRAWINGS

Certain embodiments of the invention will hereafter be described with reference to the accompanying drawings, wherein like reference numerals denote like elements, and:

FIG. 1 is a front elevation view of a well equipment string positioned in a wellbore with an energy conversion system, according to an embodiment of the present invention;

FIG. 2 is a schematic view of the energy conversion system illustrated in FIG. 1, according to an embodiment of the present invention;

FIG. 3 is a more detailed schematic representation of one example of an energy conversion system, according to an embodiment of the present invention; and

FIG. 4 is a schematic representation of another example of an energy conversion system, according to an alternate embodiment of the present invention.

### DETAILED DESCRIPTION

In the following description, numerous details are set forth to provide an understanding of the present invention. However, it will be understood by those of ordinary skill in the art that the present invention may be practiced without these details and that numerous variations or modifications from the described embodiments may be possible.

The present invention generally relates to a system and methodology by which a physical or mechanical energy can be transferred downhole along a wellbore and converted into electrical energy for use at a downhole location. This approach enables a variety of wellbore applications that can prolong the life of batteries or other electrical energy storage units deployed downhole. In some applications the use of batteries or electric lines routed downhole can be avoided completely. By way of example, mechanical/physical energy is transferred downhole via waves directed from a remote location, e.g. a surface location, to a downhole location. The energy within the physical waves is converted to electrical energy that can be used by a downhole device. In some applications for example, the downhole device comprises an electrical energy storage unit that can be charged with the electrical energy that results from the conversion.

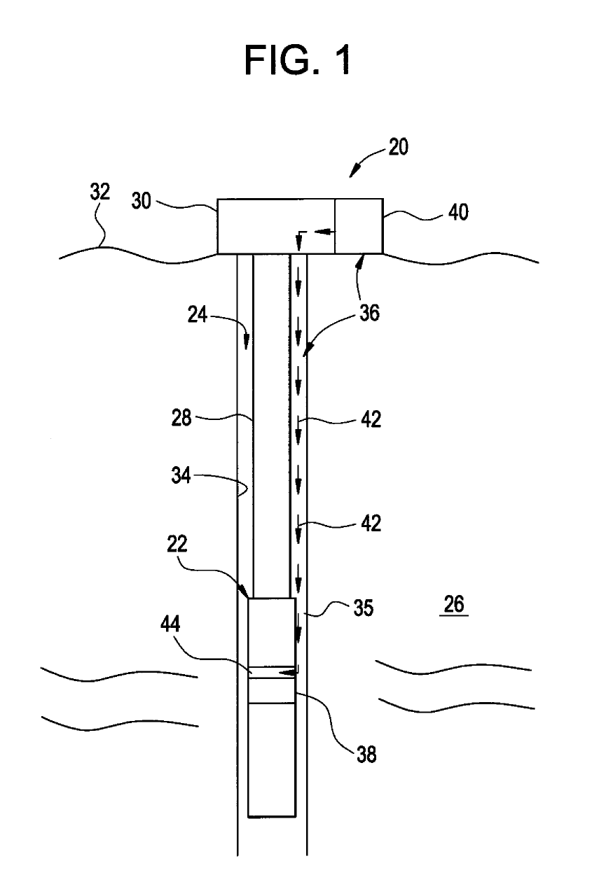

Referring generally to FIG. 1, a well system 20 is illustrated according to one embodiment of the present invention. Well system 20 comprises a well equipment string 22 deployed in a wellbore 24 that is drilled or otherwise formed in a geological formation 26. The well equipment string 22 is deployed downhole by an appropriate deployment system 28 that may be a tubing string formed of, for example, coil tubing or jointed tubing. The deployment system 28 extends downwardly along wellbore 24 from a wellhead 30 positioned at a surface 32, such as a seabed floor or the surface of the earth. The wellbore 24 is defined by a wellbore wall 34 that may be an open wellbore wall or a wellbore casing. The wellbore wall 34 is the radially outlying limit of an annulus 35 surrounding well equipment string 22 and tubing string 28.

Well system 20 also comprises an energy conversion system 36 by which energy is transmitted downhole in one form and converted to another form for use by one or more well devices 38. The well devices 38 may be mounted in well equipment string 22 or at other locations within wellbore 24. The energy conversion system 36 comprises a remote mechanism 40 that may be located at surface 32 or at other suitable locations to generate a mechanical or physical energy that can be transferred downhole as represented by arrows 42. The energy transferred downhole is received by a converter 44 which converts the physical/mechanical energy into electrical energy for use by a device or devices 38.

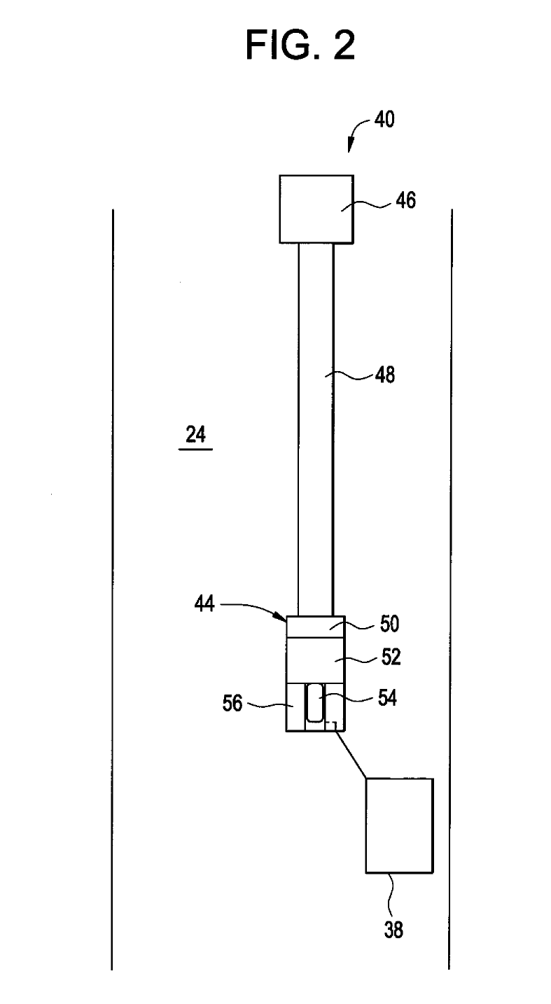

One embodiment of energy conversion system 36 is schematically illustrated in FIG. 2 as deployed in wellbore 24. However, features of well equipment string 22 and deployment system 28 have been omitted to facilitate explanation. In the embodiment illustrated, the remote mechanism 40 used in generating the physical energy comprises a wave generator 46 designed to generate waves that travel along a fluid channel 48. The fluid channel 48 may comprise annulus 35 which is filled or allowed to fill with a fluid that serves as a medium for carrying the waves generated by wave generator 46. However, the well system 20 can be designed to utilize other fluid channels for carrying the wave energy downhole.

As the waves move downhole along fluid channel 48, energy is carried to energy converter 44 which changes the form of the energy to electrical energy that can be provided to one or more devices 38. The specific form of the energy converter 44 depends on the type of mechanical/physical energy transferred downhole and the manner in which that energy is directed to converter 44. In the embodiment illustrated, however, energy converter 44 comprises a pressure balanced membrane 50 that is acted on by the waves. The pressure balanced membrane 50 is coupled to a Helmholtz cavity 52 that drives a coil 54 located within a permanent magnetic field. The magnetic field may be created by permanent magnets 56 placed around coil 54. By driving the coil 54 within the permanent magnetic field, electrical energy is created and an electrical current can be output to device 38. The electrical output can be maximized by operating wave generator 46 to produce waves at the resonant frequency of the Helmholtz cavity.

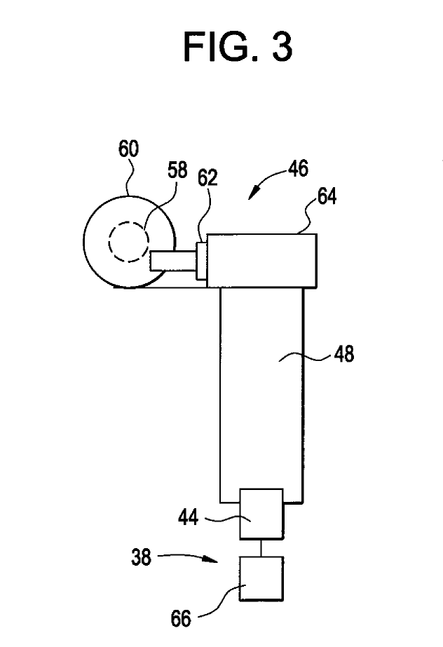

One method of creating waves at the resonant frequency of the Helmholtz cavity is through the use of an acoustic source or acoustic generator, as illustrated in FIG. 3. In this embodiment, wave generator 46 is an acoustic generator designed to produce acoustic waves and positioned to direct the acoustic waves downhole through fluid channel 48. One embodiment of the acoustic wave generator 46 comprises a motor 58 coupled to a drive 60. Motor 58 rotates drive 60 which, in turn, reciprocates a piston 62 within a housing 64, e.g. a cylinder. The piston 62 is in fluid in communication with the fluid in fluid channel 48. Thus, as piston 62 reciprocates, it creates acoustic waves that travel downwardly along fluid channel 48 to converter 44. The speed at which piston 62 reciprocates can be adjusted to maximize electrical output from converter 44. For example, the reciprocation rate can be adjusted to produce acoustic waves at the resonant frequency of Helmholtz cavity 52 when the converter embodiment of FIG. 2 is utilized.

In the embodiment illustrated in FIG. 3, device 38 comprises an electrical energy storage unit 66. Depending on the application, electrical energy storage unit 66 may comprise a rechargeable battery, a capacitor, or another type of storage unit that can be utilized to store electrical energy output by converter 44. The storage unit 66 also may comprise other components to facilitate storage of electrical energy. For example, in the embodiment illustrated in FIG. 2, the output from converter 44 is an alternating current. With this embodiment, electrical energy storage unit 66 also may comprise a transformer and a rectifier to produce direct current for charging a capacitor or a rechargeable battery. The energy stored in storage unit 66 can then later be utilized by another downhole device.

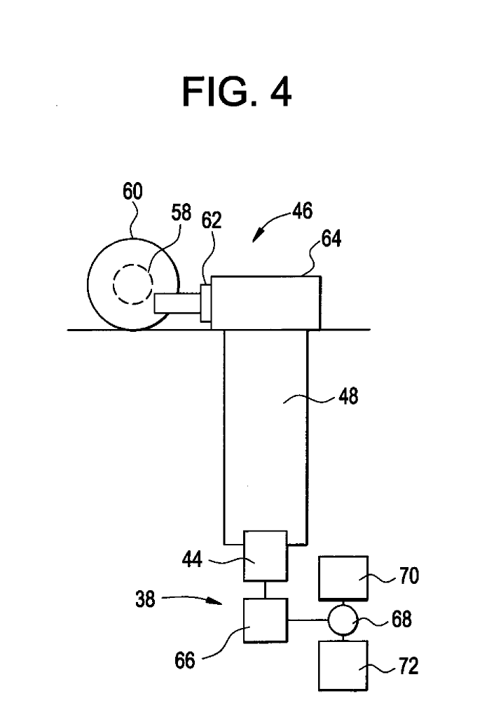

For example, in the embodiment illustrated in FIG. 4 the energy stored in unit 66 is used to operate a switch 68. When the energy in electrical energy storage unit 66 is sufficiently charged, e.g. the output voltage has reached a critical level, it drives switch 68 which connects a stored energy supply 70 with an electronic device 72. By way of example, electronic device 72 comprises any electronic controller that functions as a receiver to receive commands sent downhole. Furthermore, stored energy supply 70 may comprise a pack of non-rechargeable batteries or other electrical storage units. Because switch 68 connects electronic device 72 to stored energy supply 70 only when needed, the life of stored energy supply 70, e.g. non-rechargeable batteries, is substantially increased.

The energy stored in energy supply 70 may be used in a variety of ways depending on the specific wellbore application. For example, the energy may be used to power an acoustic or pressure detector. This type of detector senses the static or dynamic pressure in fluid channel 48, thus allowing communication from the surface to electronic device/controller 72 through controlled variations in pressure exerted on fluid channel 48 at the surface. By encoding information into the pressure variations, the downhole electronic controller can be commanded to undertake specific actions, including opening or closing valves, actuating packers, actuating sliding sleeves, causing the ignition of perforating charges or other charges, and/or selectively releasing chemicals in the wellbore.

In other embodiments, the energy can be used to power measuring instruments located downhole or to power a communication system for transmitting measurement data to the surface. By way of example, the measurement data can be transmitted uphole by using electro-magnetic telemetry, acoustic telemetry, or by modulating the acoustic reflectivity at the base of fluid channel 48.

In other alternate embodiments, stored energy supply 70 can be omitted, and the energy contained in the rechargeable electrical energy storage unit 66 can be used directly to perform downhole operations, e.g. to actuate a downhole well device. In this latter embodiment, switch 68 can be set to prevent energy use until unit 66 is sufficiently charged to carry out the desired operation.

The conversion of mechanical/physical energy into electrical energy at a downhole location can be useful in a variety of well related applications. Furthermore, once converted to electrical energy, this energy can be used to provide power to a variety of devices. The electrical energy can be used to recharge batteries, to turn on switches or other devices, or to actuate devices that are powered by other downhole energy sources. For example, the electrical energy can be used to turn on a dormant receiver which is then able to receive communications signals from the surface location, thereby increasing the life of the battery or other energy source used to power the receiver. In other applications, the electrical energy supplied by the converter can be used alone, i.e. without the aid of a separate electrical energy storage unit, to accomplish a desire downhole function.

Accordingly, although only a few embodiments of the present invention have been described in detail above, those of ordinary skill in the art will readily appreciate that many modifications are possible without materially departing from the teachings of this invention. Such modifications are intended to be included within the scope of this invention as defined in the claims.

1. A method for ensuring available power in a downhole environment, comprising:
generating acoustic waves;
directing the acoustic waves downhole into a wellbore;
converting the acoustic waves into electrical energy at a downhole location; and
using the electrical energy to provide power to a downhole device.

2. The method as recited in claim 1, wherein using comprises using the electrical energy to recharge a battery.

3. The method as recited in claim 1, wherein using comprises using the electrical energy to turn on a device.

4. The method as recited in claim 1, wherein using comprises using the electrical energy to turn on a device powered by a downhole energy source.

5. The method as recited in claim 1, wherein using comprises using the electrical energy to turn on a dormant receiver so as to receive communication signals.

6. The method as recited in claim 1, wherein using comprises using the electrical energy to power a downhole device.

7. The method as recited in claim 1, wherein directing comprises directing the acoustic waves downhole along a fluid channel.

8. The method as recited in claim 1, wherein directing comprises directing the acoustic waves downhole through an annulus between a wellbore wall and a well equipment string deployed in the wellbore.

9. The method as recited in claim 1, wherein converting comprises utilizing a pressure balanced membrane coupled to a Helmholtz cavity to drive a coil in a magnetic field.

10. A system, comprising:
a well system having a fluid channel extending downhole;
an acoustic generator positioned to direct acoustic waves downhole through the fluid channel; and
a converter positioned downhole to receive the acoustic waves and to convert the energy of the acoustic waves to electrical energy.

11. The system as recited in claim 10, further comprising a well equipment string positioned in the wellbore.

12. The system as recited in claim 10, wherein the acoustic generator is positioned at a surface location.

13. The system as recited in claim 10, further comprising an electrical device positioned downhole and coupled to the converter to receive the electric energy.

14. The system as recited in claim 13, wherein the electrical device comprises an energy storage unit.

15. The system as recited in claim 13, wherein the electrical device comprises a receiver that may be turned on with the electrical energy.

16. The system as recited in claim 13, wherein the electrical device comprises an electrically powered device operated on the electrical energy supplied by the converter.

17. The system as recited in claim 13, wherein the electrical device is used to turn on a dormant device coupled to a separate power supply.

18. A method, comprising:
providing mechanical pulses downhole along a wellbore; and
converting the mechanical pulses to electrical energy at a downhole location.

19. The method as recited in claim 18, further comprising storing the electrical energy in an energy storage unit located downhole.

20. (canceled)

21. The method as recited in claim 18, wherein providing comprises generating acoustic waves and directing the acoustic waves along a fluid channel in the wellbore.

22. The method as recited in claim 18, wherein converting comprises utilizing a Helmholtz cavity.

23. A system, comprising:
a wave generator to generate fluid waves;
a fluid channel connecting the wave generator to a subterranean location; and
a converter positioned at the subterranean location to convert the energy of the fluid waves into electric energy.

24. The system as recited in claim 23, wherein the wave generator comprises an acoustic generator.

25. (canceled)

26. The system as recited in claim 23, further comprising an electric energy storage unit positioned downhole and coupled to the converter to receive the electric energy.

27. The system as recited in claim 26, further comprising a well tool coupled to the electric energy storage unit and powered at least in part by the electric energy stored in the electric energy storage unit.
